(19) United States
(12) Patent Application Publication
(10) Pub. No.: US 2006/0276238 A1
(43) Pub. Date: Dec. 7, 2006

(54) Mobile phone attachment

(76) Inventor: Gina Shepard-Vagedes, Florence, KY (US)

Correspondence Address: WOOD, HERRON & EVANS, LLP, 2700 CAREW TOWER, 441 VINE STREET, CINCINNATI, OH, 45202, US

(21) Appl. No.: 11/141,928

(22) Filed: Jun. 1, 2005

(51) Int. Cl. H04M 1/00

(52) U.S. Cl. 455/575.6

(57) ABSTRACT

An attachment member for personalizing a mobile phone includes a base member and an eyelet member extended from said base member. The eyelet member provides an opening through which a string or other similar device can extend to attach personal features to a phone. In particular, this is designed to attach a decorative lanyard or string, but can also be used to attach various other items such as a small flashlight, or keys, or the like.

### BACKGROUND OF THE INVENTION

Various methods are used to personalize mobile phones to distinguish one phone from another. Generally, these comprise snap-on plates that alter the ornamental appearance. Many phones are not suitable for such personalized changes.

Some phones are able to accept lanyards. An ornamental lanyard can be attached to these devices. However, the location is fixed and does not allow the owner to place the lanyard or decoration where he or she prefers. Others do not have such a means to attach a lanyard.

### SUMMARY OF THE INVENTION

The present invention provides a means to personalize a mobile phone. The method is suitable for virtually all mobile phones and includes an adhesively attachable eyelet that can be fixed to a mobile phone. In turn, a personalized lanyard or string can be attached to the phone, as well as other features such as key rings, and the like. The adhesively attachable eyelet can be located on various locations of the phone and provides a quick, simple, inexpensive way to personalize any phone.

The objects and advantages of the present invention will be further appreciated in light of the following detailed descriptions and drawings, in which:

### BRIEF DESCRIPTION OF THE DRAWINGS

FIG. 1 is a perspective view of an adhesively attachable eyelet for use in the present invention.

FIG. 2 is a perspective view of a mobile phone with the eyelet from FIG. 1 attached.

FIG. 3 is a perspective view of a mobile phone showing alternate locations for the eyelet shown in FIG. 1.

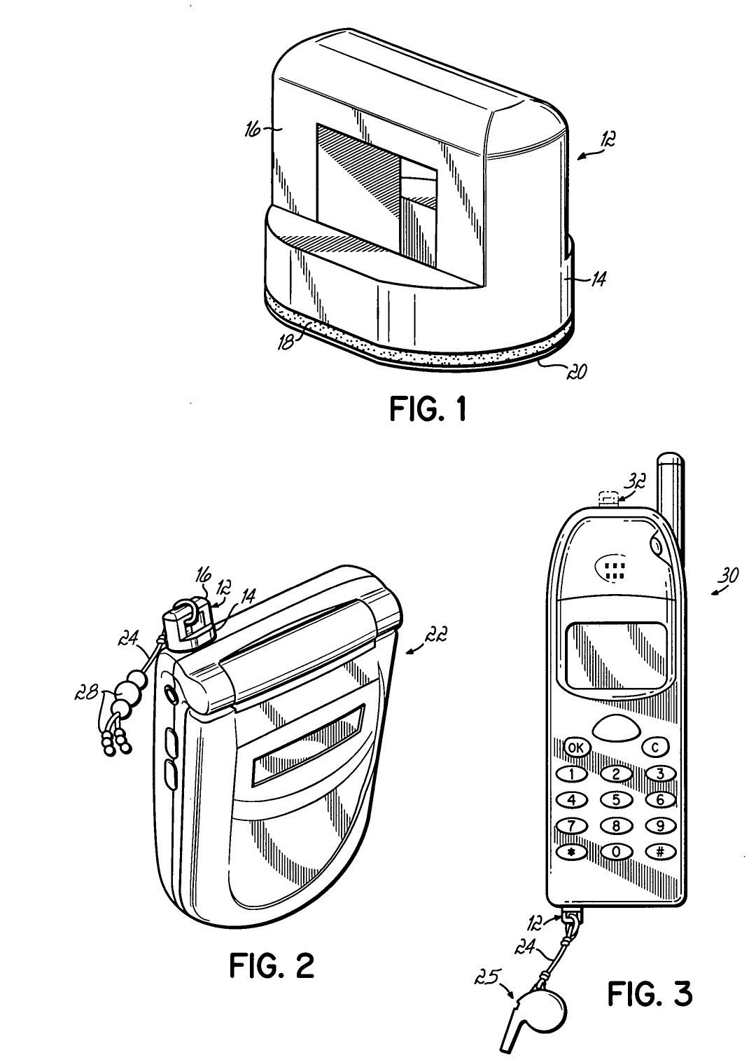

### DETAILED DESCRIPTION OF THE INVENTION

The present invention provides a method to personalize a mobile phone. More particularly, the present invention comprises an attachment member 12 that includes a base portion 14 and an eyelet portion 16 that extends upwardly from the base portion 14. The bottom surface of base 14 is covered with a layer of pressure sensitive adhesive 18 which, in turn can be covered with a release sheet 20. This can be replaced with any type of adhesive or glue that will adhere the base 14 to the surface of the phone. The attachment member 12 is preferably an injection molded plastic or metal material.

The attachment member 12 is affixed to a mobile phone 22 as shown in FIG. 2. To accomplish this, the release sheet 20 is removed, exposing the layer of pressure sensitive adhesive 18. This is then pressed against the surface of the phone 22 causing it to adhere thereto.

Alternately, a thermosetting adhesive or glue can be applied separately. In particular, acrylic based adhesives are particularly suited for such an application. Once the attachment member 12 is affixed to the phone 22, a lanyard or other decorative item can be attached to the phone via the eyelet portion 16. As shown in FIG. 2, a decorative lanyard 24 or string holds decorative beads 28, or other decorative items, such as zodiac signs.

Other functional items can be attached to the phone using attachment member 12. A set of keys can be attached using a key ring. A small flashlight, or whistle 25 (as shown in FIG. 3), or the like, can also be attached. Alternately, the eyelet 16 can be open at one end forming a hook which may or may not include a release mechanism or latch.

The attachment member 12 can be affixed to virtually any phone. As shown in FIG. 3, a different embodiment of a phone 30 is modified with the attachment member 12 and the decorative lanyard 24. An alternate placement of the attachment member is shown in phantom labeled 32 showing that this can be positioned virtually anywhere on the mobile phone as desired by the user.

Thus, the present invention allows one to customize a mobile phone quickly, easily, and inexpensively. The same device works for virtually all phones and can be used in various locations, as desired by the user.

This has been a description of the present invention along with the preferred method of practicing the present invention. However, the invention itself should only be defined by the appended claims, WHEREIN

I claim:

1. An attachment member for a mobile phone comprising a base member having an adhesive or glue on said base member adapted to affix to a mobile phone, an eyelet member extending upwardly from said base member.

2. A mobile phone having the attachment member claimed in claim 1 affixed thereto.

3. The mobile phone claimed in claim 2 further comprising a decorative lanyard attached to said attachment member comprising a string member extending through an opening in said eyelet member.

4. The attachment member claimed in claim 2 wherein said attachment member is affixed to said mobile phone with a pressure sensitive adhesive.

5. The mobile phone claimed in claim 2 wherein said attachment member is affixed to said phone with a thermoset adhesive.

6. The mobile phone claimed in claim 5 wherein said thermoset adhesive is any acrylic thermoset adhesive.
